(19) United States
(12) Patent Application Publication
(10) Pub. No.: US 2019/0276292 A1
(43) Pub. Date: Sep. 12, 2019

(54) HYDRAULIC DRIVE DEVICE FOR CARGO VEHICLE

(71) Applicant: KABUSHIKI KAISHA TOYOTA JIDOSHOKKI, Kariya-shi, Aichi-ken (JP)

(72) Inventor: Yuki UEDA, Aichi-ken (JP)

(73) Assignee: KABUSHIKI KAISHA TOYOTA JIDOSHOKKI, Kariya-shi, Aichi-ken (JP)

(21) Appl. No.: 16/461,146

(22) PCT Filed: Oct. 20, 2017
(86) PCT No.: PCT/JP2017/037952

§ 371 Date: May 15, 2019

(30) Foreign Application Priority Data
Nov. 16, 2016 (JP) 2016-223438

(51) Int. Cl. B66F 9/22; F15B 11/16

(52) U.S. Cl. CPC B66F 9/22; F15B 11/16; F15B 2211/20515; F15B 2211/275; F15B 2211/71; F15B 2211/45; F15B 2211/6651; F15B 2211/6346; F15B 2211/7053; F15B 2211/41581

(57) ABSTRACT

A hydraulic drive device for a cargo vehicle includes a first hydraulic cylinder for raising and lowering, a second hydraulic cylinder for performing an operation different from the first hydraulic cylinder, a first operation member, a second operation member, a hydraulic pump, an electric motor, a lowering oil path, an operation valve, a bypass oil path that branches off from the lowering oil path, a bypass flow rate control valve in the bypass oil path, a command rotational speed setting unit that sets a command rotational speed of the electric motor, and an electric motor control unit. A command rotational speed deceleration which is a deceleration of the command rotational speed set by the command rotational speed setting unit is larger than an actual rotational speed deceleration which is a deceleration of an actual rotational speed of the electric motor by the controlling output of the electric motor control unit.

### TECHNICAL FIELD

The present invention relates to a hydraulic drive device for a cargo vehicle.

### BACKGROUND ART

As a hydraulic drive device of a cargo vehicle, for example, a device described in Patent Document 1 is known. The hydraulic drive device disclosed in Patent Document 1 includes a hydraulic cylinder for raising and lowering that raises and lowers an object to be raised and lowered by supplying and discharging hydraulic oil, an operation member for raising and lowering that operates the hydraulic cylinder for raising and lowering, a hydraulic pump that supplies and discharges hydraulic oil to and from the hydraulic cylinder for raising and lowering, a motor that drives the hydraulic pump, an operation valve that is disposed between the suction port of the hydraulic pump and the bottom chamber of the hydraulic cylinder for raising and lowering and that controls the flow of hydraulic oil based on the operation amount of the lowering operation of the operation member for raising and lowering.

### CITATION LIST

### Patent Document

Patent Document 1: U.S. Pat. No. 5,649,422

### SUMMARY OF INVENTION

### Problem that the Inventor is to Solve

Here, the above-described conventional hydraulic drive device has the following problems. That is, there is a case where the lowering speed of the hydraulic cylinder for raising and lowering fluctuates at the timing at which the rotational speed of the electric motor decreases. Therefore, it has been required to suppress the fluctuations in the lowering speed of such a hydraulic cylinder.

An object of the present invention is to provide a hydraulic drive device for a cargo vehicle capable of suppressing fluctuation in lowering speed of a hydraulic cylinder for raising and lowering.

### Solution to Problems

A hydraulic drive device for a cargo vehicle according to an aspect of the present invention includes a first hydraulic cylinder for raising and lowering that raises and lowers an object to be raised and lowered by supplying and discharging hydraulic oil, a second hydraulic cylinder for performing an operation different from the first hydraulic cylinder by supplying and discharging the hydraulic oil, a first operation member that operates the first hydraulic cylinder, a second operation member that operates the second hydraulic cylinder, a hydraulic pump that supplies and discharges the hydraulic oil to and from the first hydraulic cylinder and the second hydraulic cylinder, an electric motor connected to the hydraulic pump and functioning as a motor or a generator, a lowering oil path connecting a bottom chamber of the first hydraulic cylinder and a suction port of the hydraulic pump so that the hydraulic oil discharged from the first hydraulic cylinder flows to the suction port of the hydraulic pump, an operation valve that is disposed in the lowering oil path and that controls a flow of hydraulic oil discharged from the first hydraulic cylinder based on a lowering operation of the first operation member, a bypass oil path that branches off from the lowering oil path at a branch point and that connects the branch point and a tank that stores the hydraulic oil, a bypass flow rate control valve that is disposed in the bypass oil path and that controls a bypass flow rate which is a flow rate of hydraulic oil flowing from the branch point to the tank, a command rotational speed setting unit that sets a command rotational speed of the electric motor, and an electric motor control unit that performs a controlling output to the electric motor based on conditions of the command rotational speed of the command rotational speed setting unit and power running torque limit control, wherein a command rotational speed deceleration which is a deceleration of the command rotational speed set by the command rotational speed setting unit is larger than an actual rotational speed deceleration which is a deceleration of an actual rotational speed of the electric motor by the controlling output of the electric motor control unit.

In the hydraulic drive device for the cargo vehicle according to the present invention, the command rotational speed deceleration which is the deceleration of the command rotational speed set by the command rotational speed setting unit is greater than the actual rotational speed deceleration which is the deceleration of the actual rotational speed of the electric motor by the controlling output of the electric motor control unit. For example, when a state in which the first operation member of the first hydraulic cylinder for raising and lowering is operated independently is shifted to a state in which the first operation member and the second operation member of the second hydraulic cylinder are simultaneously operated, there is a case where the cylinder flow rate discharged from the first hydraulic cylinder is maintained while the command rotational speed and the actual rotational speed are decreased. At this time, in order to maintain the cylinder flow rate, the bypass flow rate control valve is opened, but the response of the bypass flow rate control valve cannot catch up, so that the cylinder flow rate may decrease as the actual rotational speed decreases locally. Even in such a case, since the actual rotational speed deceleration is smaller than the command rotational speed deceleration, the actual rotational speed can be gradually decreased. Accordingly, a sharp decrease in the cylinder flow rate can be suppressed in accordance with a gradual decrease in the actual rotational speed. Also, for example, a state in which the actual rotational speed is lower than the command rotational speed (for example, the oil temperature is low), and the power running torque limit control is being performed may be shifted to a state in which the command rotational speed decreases, and the power running torque limit control is released. In this case, the actual rotational speed increases toward the command rotational speed, and accordingly the cylinder flow rate also increases. In this case, since the command rotational speed deceleration is greater than the actual rotational speed deceleration, the command rotational speed can be promptly decreased. Therefore, the actual rotational speed speedily becomes equal to the command rotational speed, and the increase in the actual rotation can be suppressed. Accordingly, an increase in the cylinder flow rate may be suppressed. As described above, since the local fluctuations in the cylinder flow rate of the first hydraulic cylinder may be suppressed, the fluctuations in lowering speed of the first hydraulic cylinder may be suppressed.

Further, in the hydraulic drive device for the cargo vehicle according to another aspect of the present invention, the command rotational speed deceleration may be two times or more as large as the actual rotational speed deceleration. This permit providing a sufficient difference between the command rotational speed deceleration and the actual rotational speed deceleration, so that the more significant effect of suppressing the fluctuations in lowering speed of the first hydraulic cylinder may be obtained.

### Advantageous Effects of Invention

According to the present invention, fluctuations in lowering speed of the hydraulic cylinder for raising and lowering may be suppressed.

### BRIEF DESCRIPTION OF THE DRAWINGS

FIG. 1 is a side view showing a cargo vehicle including a hydraulic drive device according to an embodiment of the present invention.

FIG. 2 is a hydraulic circuit diagram showing a hydraulic drive device according to an embodiment of the present invention.

FIG. 3 is a configuration diagram showing a control system of the hydraulic drive device shown in FIG. 2.

FIG. 4 is a block configuration diagram showing the control system of the hydraulic drive device shown in FIG. 2.

FIG. 5 is a flowchart showing a control process performed by a controller shown in FIG. 3.

FIG. 6 shows a block configuration diagram more simply describing a control system of a hydraulic drive device for a cargo vehicle.

FIGS. 7A and 7B are charts showing a relation among a command rotational speed, an actual rotational speed, and a cylinder flow rate according to a comparative example in which the command rotational speed deceleration and the actual rotational speed deceleration are set at a large value.

FIGS. 8A and 8B are charts showing a relation among a command rotational speed, an actual rotational speed, and a cylinder flow rate according to the comparative example in which the command rotational speed deceleration and the actual rotational speed deceleration are set to a small value.

FIGS. 9A and 9B are charts showing a relation among a command rotational speed, an actual rotational speed, and a cylinder flow rate according to the present embodiment in which the command rotational speed deceleration is set at a large value and the actual rotational speed deceleration is set to a small value.

### DESCRIPTION OF EMBODIMENTS

Hereinafter, a preferred embodiment of a hydraulic drive device for a cargo vehicle according to the present invention will be described in detail with reference to the drawings. In the drawings, the same or equivalent elements are denoted by the same reference numerals, and redundant description is omitted.

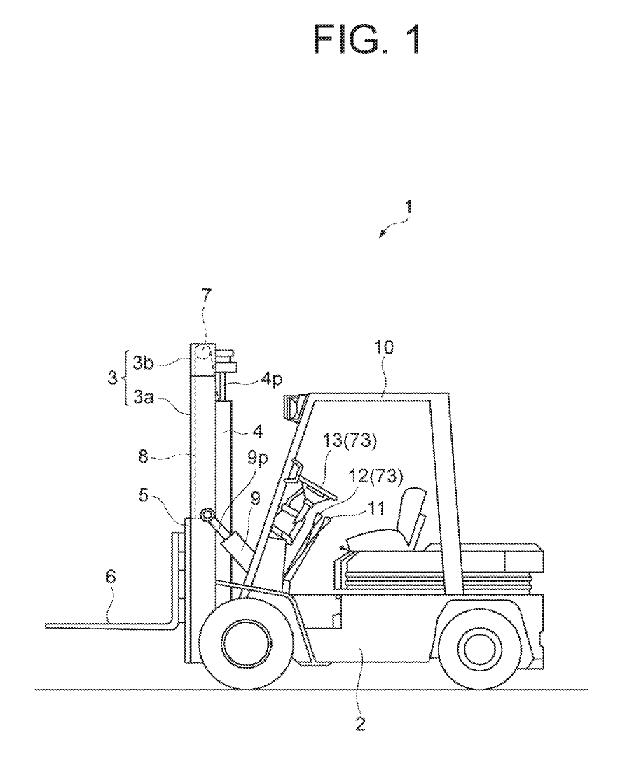

FIG. 1 is a side view showing a cargo vehicle including a hydraulic drive device according to an embodiment of the present invention. In the figure, a cargo vehicle 1 according to the present embodiment is a battery-operated forklift. The cargo vehicle 1 includes a vehicle body frame 2 and a mast 3 disposed at the front portion of the vehicle body frame 2. The mast 3 includes a pair of right and left outer masts 3a tiltably supported by the vehicle body frame 2 and inner masts 3b arranged inward of the outer masts 3a and capable of moving up and down with respect to the outer masts 3a.

A lift cylinder 4 as a hydraulic cylinder for raising and lowering is disposed behind the mast 3. The tip portion of a piston rod 4p of the lift cylinder 4 is connected to the upper portion of the inner mast 3b.

A lift bracket 5 is supported on the inner mast 3b so as to be raised and lowered. A fork (object to be raised and lowered) 6 for loading a load is attached to the lift bracket 5. A chain wheel 7 is provided on the upper portion of the inner mast 3b, and a chain 8 is hung on the chain wheel 7. One end portion of the chain 8 is connected to the lift cylinder 4, and the other end portion of the chain 8 is connected to the lift bracket 5. With the expansion and the contraction of the lift cylinder 4, the fork 6 is raised and lowered together with the lift bracket 5 through the chain 8.

Tilt cylinders 9 as tilting hydraulic cylinders are supported on the left and right sides of the vehicle body frame 2, respectively. The tip portion of a piston rod 9p of the tilt cylinder 9 is rotatably connected to a substantially central portion of the outer mast 3a in the height direction thereof. The mast 3 tilts with the expansion and the contraction of the tilt cylinder 9.

An operator cabin 10 is provided on the upper portion of the vehicle body frame 2. A lift operation lever (first operation member) 11 for operating the lift cylinder 4 to raise and lower the fork 6 and an tilt operation lever 12 for operating the tilt cylinder 9 to tilt the mast 3 are provided in the front portion of the operator cabin 10.

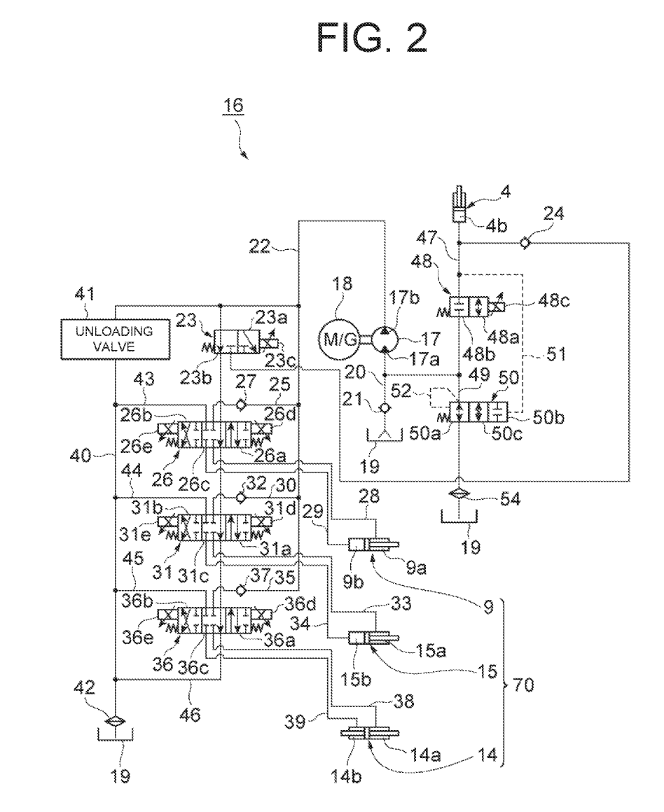

Additionally, a steering wheel 13 for steering is provided in the front portion of the operator cabin 10. The steering wheel 13 is of a hydraulic power steering, and configured to assist the steering by the driver by a PS cylinder 14 (see FIG. 2) as a power steering (PS) hydraulic cylinder.

Further, the cargo vehicle 1 is provided with an attachment cylinder 15 (see FIG. 2) as an attachment hydraulic cylinder for operating attachments (not shown). The attachments include attachments for moving the fork 6 to the left and right, or tilting or rotating the fork 6. An attachment operation lever (not shown) for operating the attachment by operating the attachment cylinder 15 is provided in the operator cabin 10.

Further, though not specifically shown in the illustration, a direction switch for switching the traveling direction (forward/backward/neutral) of the cargo vehicle 1 is provided in the operator cabin 10.

FIG. 2 is a hydraulic circuit diagram showing a first embodiment of the hydraulic drive device according to the present invention. In the figure, a hydraulic drive device 16 of the present embodiment is a device that drives the lift cylinder 4, the tilt cylinder 9, the attachment cylinder 15 and the PS cylinder 14.

The hydraulic drive device 16 includes a single hydraulic pump motor 17 and a single electric motor 18 that is connected to the hydraulic pump motor 17 and drives the hydraulic pump motor 17. The hydraulic pump motor 17 has a suction port 17a for drawing hydraulic oil and a discharge port 17b for discharging hydraulic oil. The hydraulic pump motor 17 is configured to rotate in one direction.

The electric motor 18 functions as a motor and a generator. More specifically, when the hydraulic pump motor 17 operates as a hydraulic pump, the electric motor 18 functions as a motor, and when the hydraulic pump motor 17 operates as a hydraulic motor, the electric motor 18 functions as a generator. When the electric motor 18 functions as a generator, electric power generated by the electric motor 18 is stored in a battery (not shown). That is, the regeneration operation is performed.

A tank 19 configured to store hydraulic oil is connected to the suction port 17a of the hydraulic pump motor 17 through a hydraulic pipe 20. The hydraulic pipe 20 is provided with a check valve 21 that allows hydraulic oil to flow only in a direction from the tank 19 to the hydraulic pump motor 17. The hydraulic pump motor 17 functions as a pump that supplies hydraulic oil to the lift cylinder 4 during the raising operation by the lift operation lever 11, and functions as a hydraulic motor driven by the hydraulic oil discharged from the lift cylinder 4 during the lowering operation by the lift operation lever 11.

The discharge port 17b of the hydraulic pump motor 17 and a bottom chamber 4b of the lift cylinder 4 are connected through a hydraulic pipe 22. An electromagnetic proportional valve 23 for raising lift is disposed in the hydraulic pipe 22. The electromagnetic proportional valve 23 is switched between an open position 23a that allows the flow of the hydraulic oil from the hydraulic pump motor 17 to the bottom chamber 4b of the lift cylinder 4 and a closed position 23b that shuts off the flow of the hydraulic oil from the hydraulic pump motor 17 to the bottom chamber 4b of the lift cylinder 4.

The electromagnetic proportional valve 23 is normally in the closed position 23b (shown), and is switched to the open position 23a when an operation signal (a lift raising solenoid current command value corresponding to the operation amount of the raising operation of the lift operation lever 11) is input to a solenoid operation unit 23c. Thus, hydraulic oil is supplied from the hydraulic pump motor 17 to the bottom chamber 4b of the lift cylinder 4, the lift cylinder 4 is expanded, and the fork 6 is raised accordingly. It is noted that the electromagnetic proportional valve 23 opens with an opening in accordance with the operation signal when the electromagnetic proportional valve 23 is in the open position 23a. A check valve 24, which allows hydraulic oil to flow only in the direction from the electromagnetic proportional valve 23 to the lift cylinder 4, is provided between the electromagnetic proportional valve 23 and the lift cylinder 4 in the hydraulic pipe 22.

An electromagnetic proportional valve 26 for tilting is connected to a branch point between the hydraulic pump motor 17 and the electromagnetic proportional valve 23 in the hydraulic pipe 22 through a hydraulic pipe 25. The hydraulic pipe 25 is provided with a check valve 27 that allows hydraulic oil to flow only in the direction from the hydraulic pump motor 17 to the electromagnetic proportional valve 26.

The electromagnetic proportional valve 26 is connected to a rod chamber 9a and a bottom chamber 9b of the tilt cylinder 9 through hydraulic pipes 28 and 29, respectively. The electromagnetic proportional valve 26 is switched between an open position 26a that allows the flow of the hydraulic oil from the hydraulic pump motor 17 to the rod chamber 9a of the tilt cylinder 9, an open position 26b that allows the flow of the hydraulic oil from the hydraulic pump motor 17 to the bottom chamber 9b of the tilt cylinder 9, and a closed position 26c that shuts off the flow of the hydraulic oil from the hydraulic pump motor 17 to the tilt cylinder 9.

The electromagnetic proportional valve 26 is normally in the closed position 26c (shown), and is switched to the open position 26a when an operation signal (a tilt solenoid current command value corresponding to the operation amount of the rearward tilt operation of the tilt operation lever 12) is input to a solenoid operation unit 26d on the open position 26a side and is switched to the open position 26b when an operation signal (a tilt solenoid current command value in accordance with the operation amount of the forward tilt operation of the tilt operation lever 12) is input to a solenoid operation unit 26e on the open position 26b side. When the electromagnetic proportional valve 26 is switched to the open position 26a, hydraulic oil is supplied from the hydraulic pump motor 17 to the rod chamber 9a of the tilt cylinder 9, the tilt cylinder 9 is contracted, and the mast 3 tilts backward accordingly. When the electromagnetic proportional valve 26 is switched to the open position 26b, hydraulic oil is supplied from the hydraulic pump motor 17 to the bottom chamber 9b of the tilt cylinder 9, the tilt cylinder 9 is expanded, and the mast 3 tilts forward accordingly. When the electromagnetic proportional valve 26 is in the open position 26a, 26b, the electromagnetic proportional valve 26 opens with an opening in accordance with the operation signal.

An electromagnetic proportional valve 31 for attachments is connected upstream of the check valve 27 in the hydraulic pipe 25 through a hydraulic pipe 30. The hydraulic pipe 30 is provided with a check valve 32 that allows hydraulic oil to flow only in the direction from the hydraulic pump motor 17 to the electromagnetic proportional valve 31.

The electromagnetic proportional valve 31 is connected to a rod chamber 15a and a bottom chamber 15b of the attachment cylinder 15 through hydraulic pipes 33 and 34, respectively. The electromagnetic proportional valve 31 is switched between an open position 31a that allows the flow of the hydraulic oil from the hydraulic pump motor 17 to the rod chamber 15a of the attachment cylinder 15, an open position 31b that allows the flow of the hydraulic oil from the hydraulic pump motor 17 to the bottom chamber 15b of the attachment cylinder 15, and a closed position 31c that shuts off the flow of the hydraulic oil from the hydraulic pump motor 17 to the attachment cylinder 15.

The electromagnetic proportional valve 31 is normally in the closed position 31c (shown), and is switched to the open position 31a when an operation signal (an attachment solenoid current command value corresponding to the operation amount of the attachment operation lever to one side) is input to a solenoid operation unit 31d on the open position 31a side and is switched to the open position 31b when an operation signal (an attachment solenoid current command value in accordance with the operation amount of the attachment operation lever to the other side) is input to a solenoid operation unit 31e on the open position 31b side. It is noted that the description of the operation of the attachment cylinder 15 will be omitted. When the electromagnetic proportional valve 31 is in the open position 31a, 31b, the electromagnetic proportional valve 31 opens with an opening in accordance with the operation signal.

An electromagnetic proportional valve 36 for PS is connected to upstream of the check valve 32 in the hydraulic pipe 30 via a hydraulic pipe 35. The hydraulic pipe 35 is provided with a check valve 37 that allows hydraulic oil to flow only in the direction from the hydraulic pump motor 17 to the electromagnetic proportional valve 36.

The electromagnetic proportional valve 36 is connected to a first rod chamber 14a and a second rod chamber 14b of the PS cylinder 14 through hydraulic pipes 38 and 39, respectively. The electromagnetic proportional valve 36 is switched between an open position 36a that allows the flow of the hydraulic oil from the hydraulic pump motor 17 to the first rod chamber 14a of the PS cylinder 14, an open position 36b that allows the flow of the hydraulic oil from the hydraulic pump motor 17 to the second rod chamber 14b of the PS cylinder 14, and a closed position 36c that shuts off the flow of the hydraulic oil from the hydraulic pump motor 17 to the PS cylinder 14.

The electromagnetic proportional valve 36 is normally in the closed position 36c (shown), and is switched to the open position 36a when an operation signal (a PS solenoid current command value corresponding to the operation speed of one of right and left side operations of the steering wheel 13) is input to a solenoid operation unit 36d on the open position 36a side and is switched to the open position 36b when an operation signal (a PS solenoid current command value corresponding to the operation speed of the other of right and left side operations of the steering wheel 13) is input to a solenoid operation unit 36e on the open position 36b side. It is noted that the description of the operation of the PS cylinder 14 will be omitted. When the electromagnetic proportional valve 36 is in the open positions 36a, 36b, the electromagnetic proportional valve 36 opens with an opening in accordance with the operation signal.

The branch point between the hydraulic pump motor 17 and the electromagnetic proportional valve 23 in the hydraulic pipe 22 is connected to the tank 19 through a hydraulic pipe 40. The hydraulic pipe 40 is provided with an unloading valve 41 and a filter 42. Further, the hydraulic pipe 40 is connected to the electromagnetic proportional valves 26, 31, 36 through hydraulic pipes 43, 44, 45, respectively. Further, the electromagnetic proportional valves 23, 26, 31, 36 are connected to the hydraulic pipe 40 through a hydraulic pipe 46.

The suction port 17a of the hydraulic pump motor 17 and the bottom chamber 4b of the lift cylinder 4 are connected through a hydraulic pipe (lowering oil path) 47. When the lift operation lever 11 is operated independently for lowering (the independent lowering operation of the lift operation lever 11), the hydraulic pipe 47 connects the bottom chamber 4b of the lift cylinder 4 and the suction port 17a of the hydraulic pump motor 17 so that the hydraulic oil discharged from the lift cylinder 4 flows to the suction port 17a of the hydraulic pump motor 17. A lift lowering operation valve 48 is disposed in the hydraulic pipe 47. The operation valve 48 is switched between an open position 48a that allows the flow of the hydraulic oil from the bottom chamber 4b of the lift cylinder 4 to the suction port 17a of the hydraulic pump motor 17 and a closed position 48b that shuts off the flow of the hydraulic oil from the bottom chamber 4b of the lift cylinder 4 to the suction port 17a of the hydraulic pump motor 17.

The operation valve 48 is normally in the closed position 48b (shown), and is switched to the open position 48a when an operation signal (a lift lowering solenoid current command value corresponding to the operation amount of the lowering operation of the lift operation lever 11) is input to a solenoid operation unit 48c. Then, the fork 6 is lowered due to the weight of the fork 6, the lift cylinder 4 is thus contracted, and the hydraulic oil flows out from the bottom chamber 4b of the lift cylinder 4. When the operation valve 48 is in the open position 48a, the operation valve 48 opens with an opening in accordance with the operation signal. Thus, the operation valve 48 controls a flow of hydraulic oil discharged from the lift cylinder 4 based on the lowering operation of the lift cylinder 4.

The branch point between the hydraulic pump motor 17 and the operation valve 48 in the hydraulic pipe 47 is connected to the tank 19 through a hydraulic pipe (bypass oil path) 49. In other words, the hydraulic pipe 49 is branches off from the hydraulic pipe 47 at the branch point and connects between the branch point and the tank 19 that stores hydraulic oil. A bypass flow rate control valve 50 is disposed in the hydraulic pipe 49. The bypass flow rate control valve 50 is a flow rate control valve with a pressure compensating function. The hydraulic pipe 49 is provided with a filter 54.

The bypass flow rate control valve 50 is switched between an open position 50a that allows the flow of the hydraulic oil, a closed position 50b that shuts off the flow of the hydraulic oil, and a throttle position 50c that adjusts the flow rate of the hydraulic oil. A pilot operation unit of the bypass flow rate control valve 50 on the closed position 50b side is connected upstream (front side) of the operation valve 48 through a pilot flow path 51. The pilot operation unit of the bypass flow rate control valve 50 on the open position 50a side is connected downstream (rear side) of the operation valve 48 via a pilot flow path 52. The bypass flow rate control valve 50 is opened with an opening in accordance with the pressure difference between the front and the rear of the operation valve 48. Specifically, the greater the pressure difference between the front and the rear of the operation valve 48 is, the smaller the opening of the bypass flow rate control valve 50 becomes.

Of the above-described cylinders, the tilt cylinder 9, the attachment cylinder 15, and the PS cylinder 14, which perform operations different from the lift cylinder (first hydraulic cylinder) 4 by supplying and discharging of hydraulic oil, may be collectively referred to as a “second hydraulic cylinder 70”. In addition, the tilt operation lever 12, the steering wheel 13, and the attachment operation lever, which are the levers for operating the second hydraulic cylinder 70, may be collectively referred to as a “second operation member 73.”

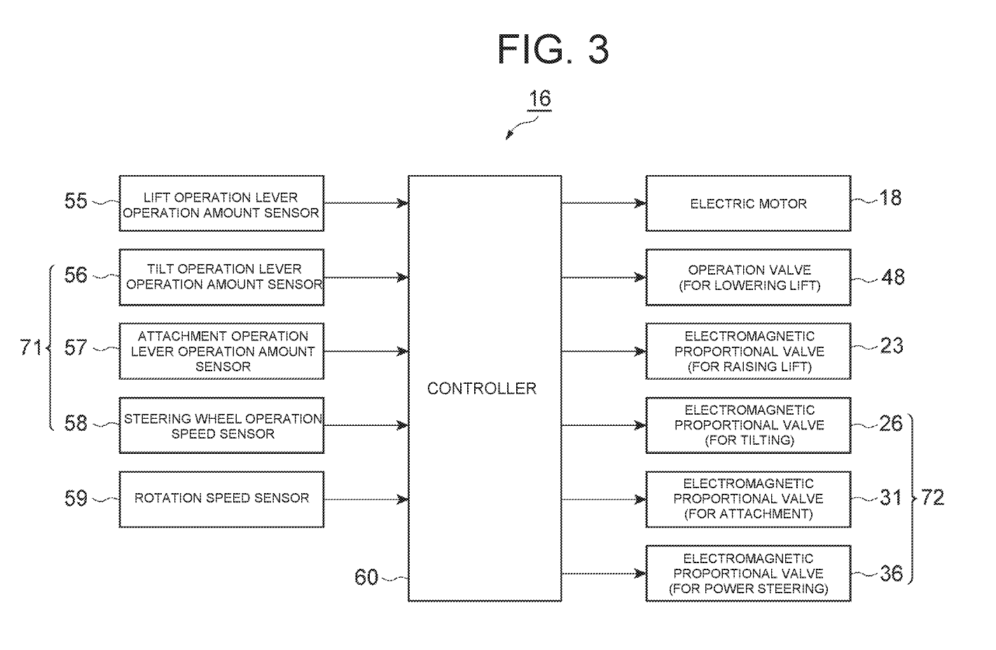

FIG. 3 is a configuration diagram showing a control system of the hydraulic drive device 16. In the figure, the hydraulic drive device 16 includes a lift operation lever operation amount sensor (operation amount detection unit) 55 that detects the operation amount of the lift operation lever 11, a tilt operation lever operation amount sensor 56 that detects the operation amount of the tilt operation lever 12, an attachment operation lever operation amount sensor 57 that detects the operation amount of the attachment operation lever (not shown), a steering wheel operation speed sensor 58 that detects the operation speed of the steering wheel 13, a rotational speed sensor 59 that detects the actual rotational speed (actual motor rotational speed) of the electric motor 18, and a controller 60.

The controller 60 receives the detection values of the operation lever operation amount sensors 55, 56, 57, the steering wheel operation speed sensor 58, and the rotational speed sensor 59, performs a predetermined process, and controls the electric motor 18, the electromagnetic proportional valves 23, 26, 31, 36, and the operation valve 48. The sensors 56, 57, 58 that detect the operation amount of the second operation member 73 may be referred to as a “second operation amount detection member 71”. Further, the electromagnetic proportional valves 26, 31, 36, which are disposed between the discharge port 17b of the hydraulic pump motor 17 and the second hydraulic cylinder and control the flow of the hydraulic oil based on the operation of the second operation member 73, may be referred to as a “second operation valve 72”.

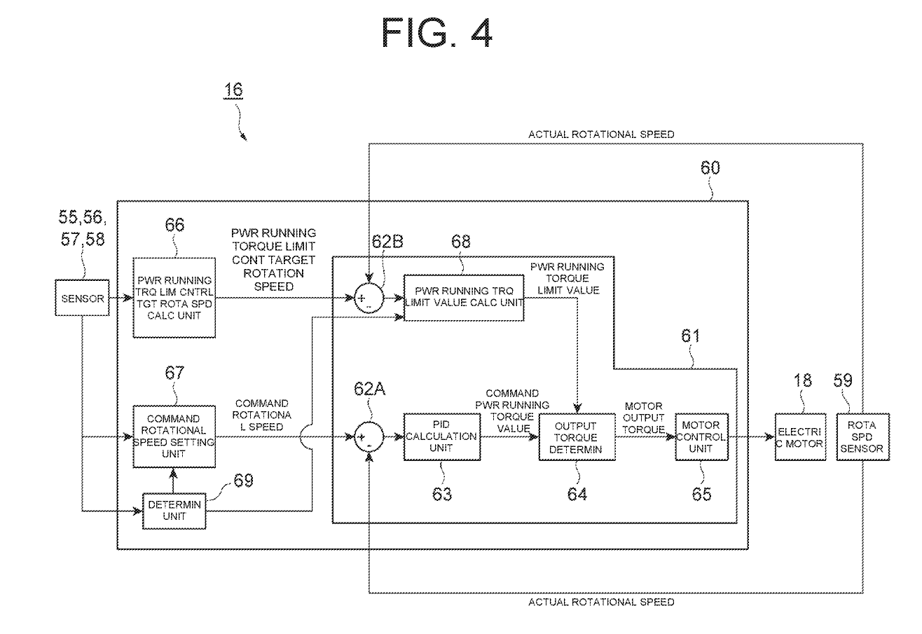

FIG. 4 is a block configuration diagram showing a block configuration of a control system of the hydraulic drive device 16. As shown in FIG. 4, the controller 60 includes a motor driver (electric motor control unit) 61, a power running torque limit control target rotational speed calculation unit 66, a command rotational speed setting unit 67, and a determination unit 69.

The motor driver 61 includes comparison units 62A and 62B, a PID calculation unit 63, a power running torque limit value calculation unit 68, an output torque determination unit 64, and a motor control unit 65. The comparison unit 62A calculates a rotational speed deviation between the command rotational speed set by the command rotational speed setting unit 67 and the actual motor rotational speed detected by the rotational speed sensor 59. The comparison unit 62B calculates a rotational speed deviation between the target rotational speed for the power running torque limit control set by the power running torque limit control target rotational speed calculation unit 66 and the actual motor rotational speed detected by the rotational speed sensor 59. The PID calculation unit 63 performs a PID calculation of the rotational speed deviation between the command rotational speed and the actual motor rotational speed to obtain a power running torque command value of the electric motor 18 so that the rotational speed deviation becomes zero. The PID calculation is a calculation in which proportional, integral and derivative actions are combined. The power running torque limit value calculation unit 68 calculates the power running torque limit value of the electric motor 18 based on the rotational speed deviation between the target rotational speed for the power running torque limit control and the actual motor rotational speed detected by the rotational speed sensor 59. The power running torque limit value is a value for limiting an increase in the output torque when the output torque of the electric motor 18 shifts toward the power running side. The power running torque limit value set by the power running torque limit value calculation unit 68 will be described later.

The output torque determination unit 64 and the motor control unit 65 control the electric motor 18 so as to achieve the rotational speed based on the command rotational speed, and control the electric motor 18 so as to achieve the rotational speed based on the power running torque limit value when the output torque of the electric motor 18 shifts toward the power running side. The output torque determination unit 64 compares the power running torque command value (which is a value based on the command rotational speed) obtained by the PID calculation unit 63 with the power running torque limit value of the electric motor 18 set by the power running torque limit value calculation unit 68 to determine the output torque of the electric motor 18. Specifically, when the power running torque command value is equal to or less than the power running torque limit value, the power running torque command value is set as the output torque of the electric motor 18. When the power running torque command value is higher than the power running torque limit value, the power running torque limit value is set as the output torque of the electric motor 18. The motor control unit 65 converts the output torque determined by the output torque determination unit 64 into a current signal and transmits such signal to the electric motor 18. It is noted that the bypass flow rate control valve 50 discharges the hydraulic oil to the tank 19 through the hydraulic pipe 49 when driving the electric motor 18 based on the command rotational speed cannot be achieved because the electric motor 18 is controlled so as to drive at the rotational speed based on the power running torque limit value.

The command rotational speed setting unit 67 acquires the detection values detected by the sensors 55, 56, 57, 58, and sets the command rotational speed based on such detected values. The command rotational speed setting unit 67 sets the command rotational speed in accordance with the operation amounts of the operation levers. The command rotational speed set by the command rotational speed setting unit 67 will be described later. The power running torque limit control target rotational speed calculation unit 66 acquires the detection values detected by the sensors 55, 56, 57, 58, and sets the target rotational speed for the power running torque limit control based on such detection values. The power running torque limit control target rotational speed calculation unit 66 sets the target rotational speed for the power running torque limit control in accordance with the operational state of the operation levers.

The determination unit 69 determines whether the lowering operation of the lift operation lever 11 is performed independently and whether the lowering operation of the lift operation lever 11 and the operation of the second operation member 73 are simultaneously performed. For example, the determination unit 69 determines that the lowering operation of the lift operation lever 11 and the operation of the second operation member 73 is performed simultaneously when the lift lowering operation and the tilt operation are performed, when the lift lowering operation and the attachment operation are performed, when the lift lowering performed and the power steering operation are performed, and when the lift lowering operation, the tilt operation and the power steering operation are performed. The determination unit 69 outputs the determination results to the command rotational speed setting unit 67 and the power running torque limit value calculation unit 68.

The command rotational speed and the power running torque limitation will now be described. When it is determined by the determination unit 69 that the lowering operation of the lift operation lever 11 is performed independently, the command rotational speed setting unit 67 sets the required lowering rotational speed for the command rotational speed. The required lowering rotational speed is a rotational speed corresponding to the flow rate necessary for the lowering operation. When it is determined by the determination unit 69 that the lowering operation of the lift operation lever 11 is performed independently, the motor driver 61 performs power running torque limit control to place a limit for the power running torque output of the electric motor 18 in order to suppress the consumption of unnecessary electric power. In executing the power running torque limit control, the power running torque limit control target rotational speed calculation unit 66 may set the preset minimum rotational speed as the target rotational speed for the power running torque limit control. This minimum rotational speed may be determined according to the specifications of the pump and the motor, and may be set at 0 rpm or a value close to 0 rpm.

When it is determined by the determination unit 69 that the lowering operation of the lift operation lever 11 and the operation of the second operation member 73 are performed simultaneously, the command rotational speed setting unit 67 sets one of values of the required lowering rotational speed and the required rotational speed of the second hydraulic cylinder that is greater than the other as the command rotational speed. Further, when it is determined by the determination unit 69 that the lowering operation of the lift operation lever 11 and the operation of the second operation member 73 are performed simultaneously, the motor driver 61 cancels the power running torque limit control and allows the power running. At this time, the power running torque limit value calculation unit 68 sets the rated power running torque for the power running torque limit value.

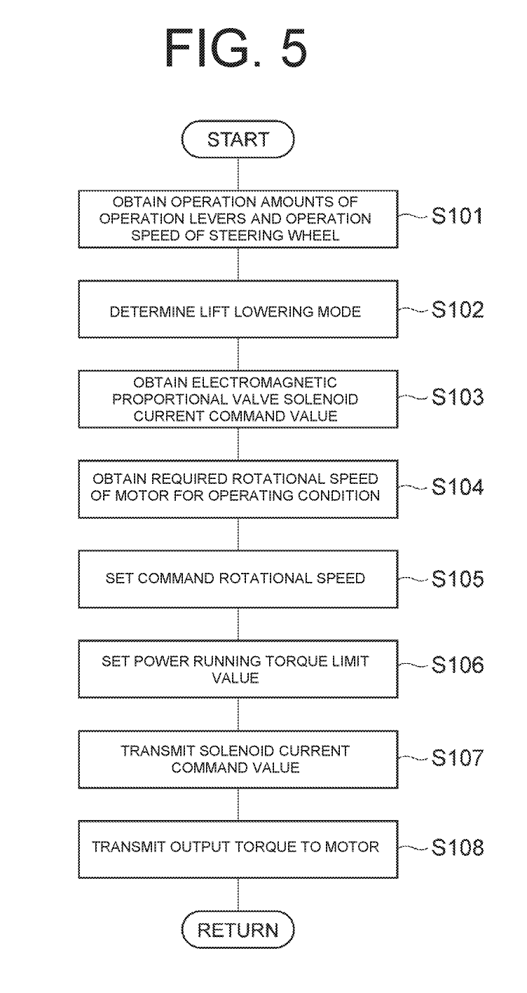

FIG. 5 is a flowchart showing a control process performed by the controller 60. It is noted that only the operation including the lowering the fork 6 (lift lowering) is subjected in this control process. Further, the cycle of executing this control process is appropriately determined by an experiment or the like.

Firstly, referring to FIG. 5, the operation amounts of the lift operation lever 11, the tilt operation lever 12, and the attachment operation lever detected by the operation lever operation amount sensors 55, 56, 57, and the operation speed of the steering wheel 13 detected by the steering wheel operation speed sensor 58 are obtained (Step S101).

Subsequently, based on the operation amounts of the lift operation lever 11, the tilt operation lever 12, the attachment operation lever, and the operation speed of the steering wheel 13 obtained at Step S101, the lift lowering mode as an operating condition is determined (Step S102). The lift lowering mode includes the independent lift lowering operation, the combination of the lift lowering operation and the tilt operation, the combination of the lift lowering and the attachment operation, the combination of the lift lowering and the power steering operation, and the combination of the lift lowering operation, the tilt operation and the power steering operation.

Then, an electromagnetic proportional valve solenoid current command value in accordance with the operation amounts of the lift operation lever 11, the tilt operation lever 12, and the attachment operation lever and the operation speed of the steering wheel 13 obtained at Step S101, the lift lowering mode determined in Step S102 (Step S103). The electromagnetic proportional valve solenoid current command value includes the lift lowering solenoid current command value in accordance with the operation amount of the lift operation lever 11 in the lowering operation, the tilt solenoid current command value corresponding to the operation amount of the tilt operation lever 12, the attachment solenoid current command value corresponding to the operation amount of the attachment operation lever, and the power steering (PS) solenoid current command value corresponding to the operation speed of the steering wheel 13.

Subsequently, the required rotational speed for the operating condition determined at Step S102 is obtained (Step S104). The required rotational speed includes a required lift motor rotational speed, a required tilt motor rotational speed, a required attachment motor rotational speed and a required power steering (PS) motor rotational speed. The required lift motor rotational speed is the rotational speed of the electric motor 18 necessary for performing the lift operation. The required tilt motor rotational speed is the rotational speed of the electric motor 18 necessary for performing the tilt operation. The required attachment motor rotational speed is the rotational speed of the electric motor 18 necessary for performing the attachment operation. The required PS motor rotational speed is the rotational speed of the electric motor 18 necessary for performing the PS operation.

Then, the command rotational speed setting unit 67 sets the command rotational speed based on the lift lowering mode determined at Step S102 and the required rotational speed determined at Step S104 (Step S105).

Subsequently, the power running torque limit value of the electric motor 18 is set based on the lift lowering mode determined at Step S102 (Step S106). The power running torque limit value is the allowable value for the power running torque.

After Step S106 is performed, the electromagnetic proportional valve solenoid current command value obtained at Step S103 is transmitted to the corresponding solenoid operation member of the electromagnetic proportional valve (Step S107). At this time, the lift lowering solenoid current command value is transmitted to the solenoid operation unit 48c of the operation valve 48. Further, when the tilt solenoid current command value is obtained, the current command value is transmitted to any one of the solenoid operation units 26d, 26e of the electromagnetic proportional valve 26, when the attachment solenoid current command value is obtained, the current command value is transmitted to any one of the solenoid operation units 31d, 31e of the electromagnetic proportional valve 31, and when the PS solenoid current command value is obtained, the current command value is transmitted to any one of the solenoid operation units 36d, 36e of the electromagnetic proportional valve 36.

Subsequently, the output torque of the electric motor 18 is determined based on the command rotational speed set at Step S105, the actual motor rotational speed detected by the rotational speed sensor 59, and the power running torque limit value of the electric motor 18 set at Step S106, and such output torque is transmitted as a control signal to the electric motor 18 (Step S108). As shown in FIG. 4, the process of Step S108 is executed by the motor driver 61 included in the controller 60.

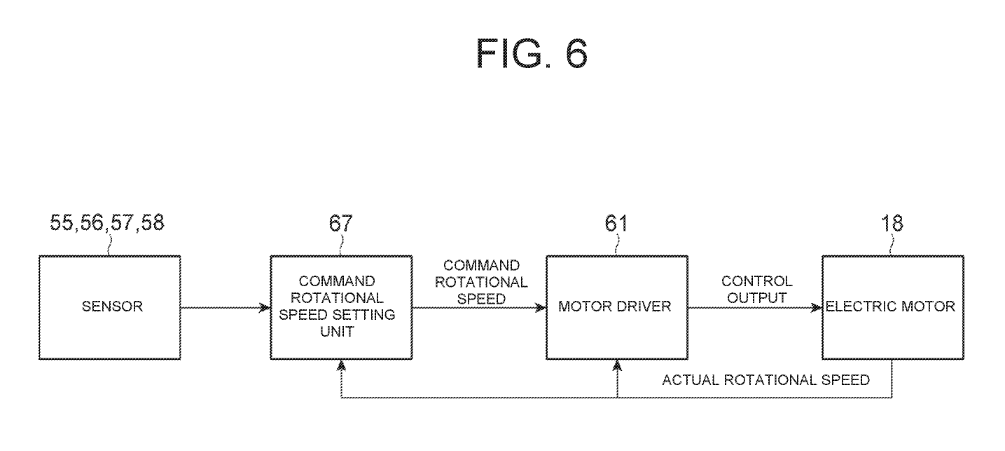

FIG. 6 shows a block configuration diagram in which the control system of the hydraulic drive device 16 for the cargo vehicle 1 is more simply shown. As shown in FIG. 6, the command rotational speed setting unit 67 sets the command rotational speed of the electric motor 18 based on the operation amounts at the respective operation units detected by the sensors 55, 56, 57, 58 as described above, and outputs it to the motor driver 61. The motor driver 61 performs an output control to the electric motor 18 based on conditions of the command rotational speed, the actual rotational speed, and the power running torque limit control of the command rotational speed setting unit 67 and the like.

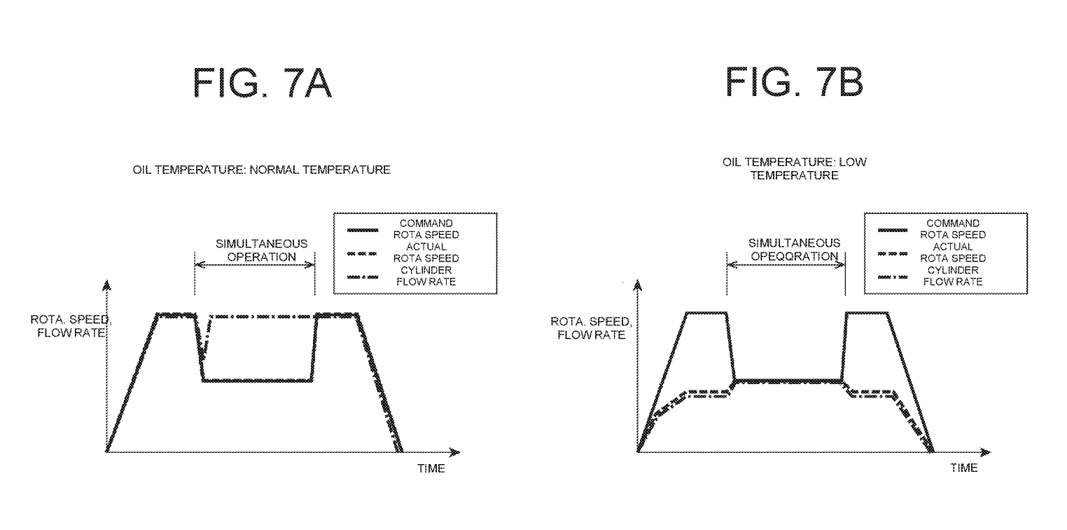

Here, when accelerating the command rotational speed, the command rotational speed setting unit 67 accelerates the command rotational speed with the command rotational speed acceleration Aa which is the acceleration of the command rotational speed. When decelerating the command rotational speed, the command rotational speed setting unit 67 decelerates the command rotational speed with the command rotational speed deceleration Ab which is the deceleration of the command rotational speed. Further, when accelerating the actual rotational speed, the motor driver 61 accelerates the actual rotational speed with the actual rotational speed acceleration Ba which is the acceleration of the actual rotational speed of the electric motor 18 by the controlling output. When decelerating the actual rotational speed, the motor driver 61 decelerates the actual rotational speed with the actual rotational speed deceleration Bb which is the deceleration of the actual rotational speed of the electric motor 18 by the controlling output. At this time, the command rotational speed deceleration Ab of the command rotational speed setting unit 67 is greater than the actual rotational speed deceleration Bb of the motor driver 61. There is no particular limitation on the extent to which the command rotational speed deceleration Ab is greater than the actual rotational speed deceleration Bb, but the command rotational speed deceleration Ab is preferable to set two times or more as great as, more preferably four times or more as large as the actual rotational speed deceleration Bb (however, when the actual rotational speed deceleration Bb is made extremely small, the followability of the rotational speed deteriorates, so that it is preferable to make it as great as possible within the range where the lowering speed fluctuation does not occur.). The command rotational speed acceleration Aa of the command rotational speed setting unit 67 may be equal to the actual rotational speed acceleration Ba of the motor driver 61, but is not limited thereto, and the command rotational speed acceleration Aa and the actual rotational speed acceleration Ba may be set at different values. The magnitude (absolute value) of the command rotational speed deceleration Ab of the command rotational speed setting unit 67 is not particularly limited, but may be greater than the magnitude of the command rotational speed acceleration Aa. That is, in the charts shown in FIGS. 7A to 9B, the absolute value of the gradient of the command rotational speed deceleration Ab may be greater than the absolute value of the gradient of the command rotational speed acceleration Aa.

The following will describe the action and effect of the hydraulic drive device 16 of the cargo vehicle 1 according to the present embodiment.

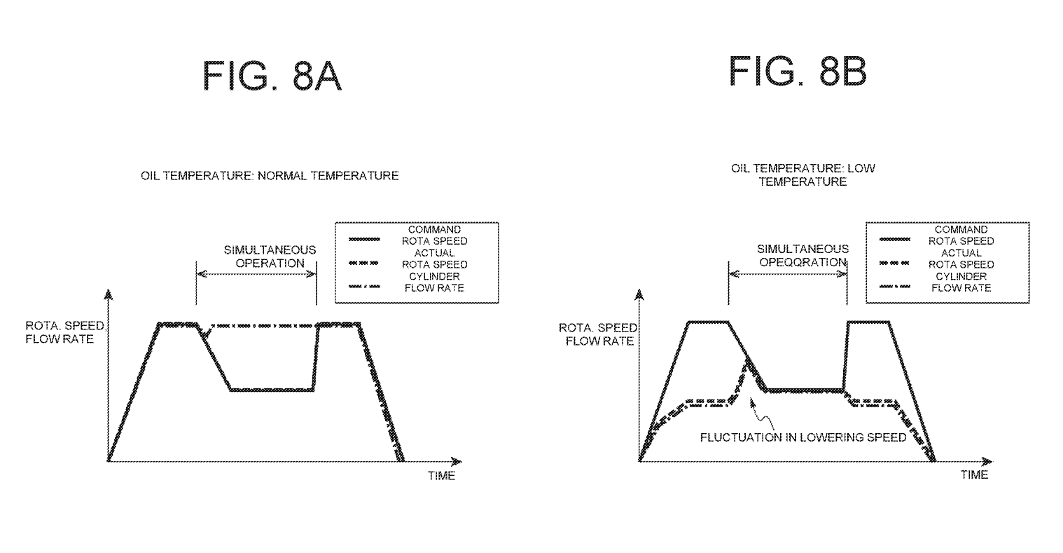

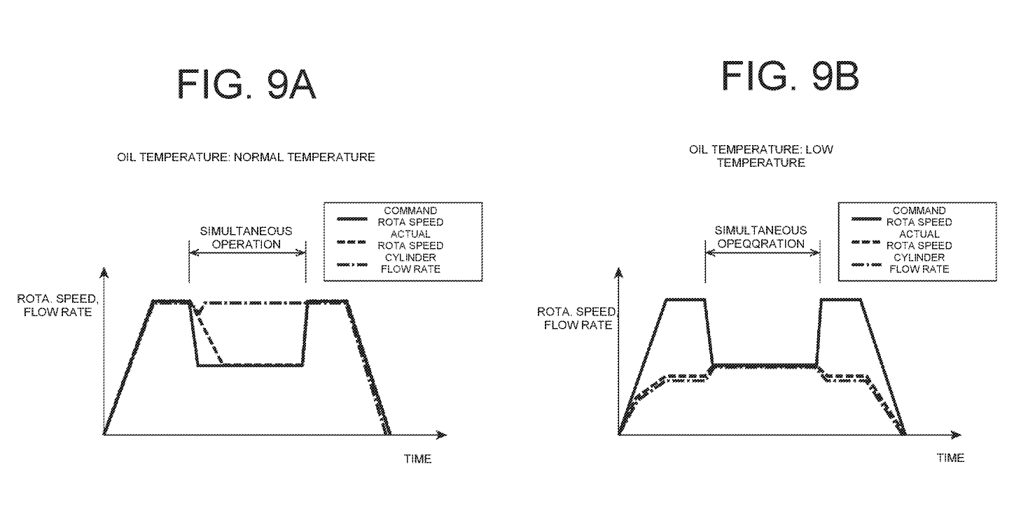

Firstly, referring to FIGS. 7A and 7B, a hydraulic drive device according to a comparative example will be described in which the command rotational speed deceleration Ab and the actual rotational speed deceleration Bb are equal to each other and both are set at large values. Referring to FIGS. 8A and 8B, a hydraulic drive device according to a comparative example will be described in which the command rotational speed deceleration Ab and the actual rotational speed deceleration Bb are equal to each other and both are set at small values. Referring to FIGS. 9A and 9B, the hydraulic drive device according to the present embodiment will be described in which the command rotational speed deceleration Ab is set at a large value and the actual rotational speed deceleration Bb is set at a small value. FIGS. 7A, 7B, 8A, 8B, 9A, and 9B are charts showing the relations between the command rotational speed, the actual rotational speed, and the cylinder flow rate discharged from the lift cylinder 4. The vertical axes indicate the rotational speed with respect to the command rotational speed and the actual rotational speed, and the flow rate of the hydraulic oil corresponding to the rotational speed with respect to the cylinder flow rate. The horizontal axes indicate time. FIGS. 7A, 8A, and 9A are charts in the case where the oil temperature of the hydraulic oil is at a normal temperature (for example, from 30 to 60° C.), and FIGS. 7B and 8B, and 9B are charts in the case where the oil temperature of the hydraulic oil is at a low temperature (for example, from −20 to 0° C.).

In FIGS. 7A and 7B, firstly, the independent operation of the lift operation lever 11 is performed. Then, simultaneous operation of the lift operation lever 11 and the second operation member 73 (indicated as “simultaneous operation” in the figure) is performed. Thereafter, the independent operation of the lift operation lever 11 is performed. Here, the required second hydraulic cylinder rotational speed is smaller than the required lowering rotational speed. Therefore, when the simultaneous operation is started, the command rotational speed decreases at the command rotational speed deceleration Ab. Since the command rotational speed deceleration Ab is set at a large value, the command rotational speed rapidly decreases. In addition, when the simultaneous operation is completed, the command rotational speed increases at the command rotational speed acceleration Aa. Also in FIGS. 8A and 8B, similarly to FIGS. 7A and 7B, the simultaneous operation is performed after the independent operation, and then the independent operation is performed. In FIGS. 8A and 8B, since the command rotational speed deceleration Ab is set at a small value, when the simultaneous operation is started, the command rotational speed gradually decreases.

As shown in FIG. 7A, when the oil temperature is at a normal temperature, the actual rotational speed changes so as to follow the command rotational speed. Here, the actual rotational speed deceleration Bb is equal to the command rotational speed deceleration Ab. Therefore, when the operation is shifted from the independent operation of the lift operation lever 11 to simultaneous operation, the actual rotational speed rapidly decreases. At this time, when the actual rotational speed decreases, of the cylinder flow rate, the flow rate which is short for the desired flow rate (cylinder flow rate corresponding to the required lowering rotational speed) is supplemented by opening the bypass flow rate control valve 50. However, the response of the bypass flow rate control valve 50 cannot catch up, and the cylinder flow rate locally decreases. This causes a problem that the lowering speed locally fluctuates.

In the case of FIG. 8A, on the other hand, when the operation is shifted from the independent operation of the lift operation lever 11 to the simultaneous operation, the actual rotational speed gradually decreases. Therefore, the response of the bypass flow rate control valve 50 may quickly catch up with the gradual fluctuations in the actual rotational speed, so that a local decrease in the cylinder flow rate may be suppressed. As a result, the local fluctuations in the lowering speed may be suppressed.

When the oil temperature is low as shown in FIG. 8B, on the other hand, the viscosity of the hydraulic oil is high, and the pressure loss increases. In addition, during the independent operation of the lift operation lever 11, the power running torque limit control is performed, so that the actual rotational speed of the electric motor 18 in which is the power running operation is not performed becomes lower than the command rotational speed due to the influence of the pressure loss of the hydraulic oil. When the simultaneous operation is performed in this state, the power running torque limit control is cancelled, and the electric motor 18 starts the power running operation, with the result that the actual rotational speed rapidly increases to the command rotational speed. The command rotational speed deceleration Ab is set at a small value, so that the decrease in the command rotational speed is gradual after the operation shifted to the simultaneous operation. Therefore, the actual rotational speed has already increased greatly at a timing at which the actual rotational speed becomes equal to the command rotational speed. Since the cylinder flow rate rises in connection with the actual rotational speed, the cylinder flow rate also temporarily rises greatly after the operation shifted to the simultaneous operation. This causes a problem that the lowering speed fluctuates locally.

In the case of FIG. 7B, on the other hand, since the command rotational speed deceleration Ab is set at a large value, the command rotational speed speedily decreases after the operation shifted to the simultaneous operation. Therefore, the actual rotational speed becomes equal to the command rotational speed before the actual rotational speed increases greatly. Along with this, a local rise in the cylinder flow rate may also be suppressed. From the above, the local fluctuations in the lowering speed may be suppressed.

As described above, there is a problem in that the lowering speed fluctuates locally in either case where the values of the command rotational speed deceleration Ab and the actual rotational speed deceleration Bb are large or where the values of the command rotational speed deceleration Ab and the actual rotational speed deceleration Bb are small.

On the other hand, in the hydraulic drive device 16 according to the present embodiment, the command rotational speed deceleration Ab of the command rotational speed setting unit 67 is set larger than the actual rotational speed deceleration Bb of the motor driver 61. Therefore, it is possible to set the command rotational speed deceleration Ab at a large value and to set the actual rotational speed deceleration Bb at a small value. Therefore, as shown in FIG. 9A, when the oil temperature is at the normal temperature, after the operation shifted to the simultaneous operation, the command rotational speed rapidly decreases, meanwhile the actual rotational speed gradually decreases. Since the response of the bypass flow rate control valve 50 may quickly catch up with the gradual fluctuations in the actual rotational speed, a local decrease in the cylinder flow rate may be suppressed. Accordingly, the local fluctuations in the lowering speed may be suppressed.

Further, as shown in FIG. 9B, when the oil temperature is low, because the command rotational speed deceleration Ab is set at a large value, the command rotational speed speedily decreases after the operation shifted to the simultaneous operation. Therefore, the actual rotational speed becomes equal to the command rotational speed before the actual rotational speed increases greatly. Accordingly, a local rise in the cylinder flow rate may also be suppressed. Thus, the local fluctuations in the lowering speed may be suppressed.

As has been described, in the hydraulic drive device 16 of the cargo vehicle 1 according to the present embodiment, the command rotational speed deceleration Ab which is the deceleration of the command rotational speed set by the command rotational speed setting unit 67 is larger than the actual rotational speed deceleration Bb which is the deceleration of the actual rotational speed of the electric motor 18 by the controlling output of the motor driver 61. As shown in FIG. 9A, when the oil temperature is at the normal temperature, in a case where the state in which the lift operation lever 11 of the lift cylinder 4 for raising and lowering is independently operated is shifted to the state in which the lift operation lever 11 and the second operation member 73 are simultaneously operated, the cylinder flow rate discharged from the lift cylinder 4 is maintained while decreasing the command rotational speed and the actual rotational speed. At this time, the bypass flow rate control valve 50 is opened in order to maintain the cylinder flow rate, but the cylinder flow rate may decrease as the actual rotational speed decreases locally due to the fact that the response of the bypass flow rate control valve 50 cannot catch up. Even in such case, the actual rotational speed can be gradually decreased because the actual rotational speed deceleration Bb is smaller than the command rotational speed deceleration Ab. Accordingly, a sharp decrease in the cylinder flow rate may be suppressed in accordance with a gradual decrease in the actual rotational speed. Further, as above-described FIG. 9B, the low temperature of the oil temperature may shift the state in which actual rotational speed is lower than the command rotational speed and the power running torque limit control is being performed (the state of the independent operation) to the state in which the command rotational speed is decreased and the power running torque limit control is cancelled (the state of the simultaneous operation). In this case, the actual rotational speed increases toward the command rotational speed, and accordingly the cylinder flow rate also increases. In this case, because the command rotational speed deceleration Ab is larger than the actual rotational speed deceleration Bb, the command rotational speed may be rapidly decreased. This causes the actual rotational speed to become equal to the command rotational speed rapidly, and the increase in the actual rotation may be suppressed. Accordingly, an increase in the cylinder flow rate may be suppressed. As described above, the local fluctuations in the cylinder flow rate of the lift cylinder 4 may be suppressed in both cases when the oil temperature is at a normal temperature and at a low temperature, the fluctuations in the lowering speed of the lift cylinder 4 may be suppressed. Since the fluctuations in the lowering speed may thus be suppressed in this manner, the operation intended by the operator may be achieved.

In the hydraulic drive device 16 of the cargo vehicle 1 according to the present embodiment, the fluctuations in the lowering speed may be suppressed without providing a special mechanism for suppressing the fluctuations in the lowering speed of the lift cylinder 4, an oil temperature sensor, a load sensor, and the like and without changing the basic configuration of the hydraulic drive device 16. Therefore, the configuration may be simplified and the cost may be reduced. In addition, maintaining the basic configuration of the hydraulic drive device 16 permits inputting loading position energy to the hydraulic pump when the lowering operation and the operation of the second operation member 73 are simultaneously performed, thus the operation with high efficiency being achieved.

Further, in the hydraulic drive device 16 of the cargo vehicle 1 according to the present embodiment, the command rotational speed deceleration Ab is two times or more as large as the actual rotational speed deceleration Bb. This permit providing a sufficient difference between the command rotational speed deceleration and the actual rotational speed, so that the more significant effect of suppressing the fluctuations in the lowering speed of the first hydraulic cylinder may be obtained.

Although a preferred embodiment of the hydraulic drive device for the cargo vehicle according to the present invention has been described above, the present invention is not limited to the above embodiment.

In the above-described embodiments, the tilt cylinder, the PS cylinder, and the attachment cylinder are provided as the second hydraulic cylinders. However, at least one cylinder is needed as the second hydraulic cylinder and part thereof may be omitted. For example, in the above embodiment, the attachment and the power steering are mounted, but the hydraulic drive device of the present invention is applicable to a forklift not equipped with the attachment and the power steering. Further, the hydraulic drive device of the present invention may be applied to any type of battery-operated cargo vehicle other than a forklift.

The electromagnetic proportional valve has been exemplified as the control valve that controls the flow of the hydraulic oil based on the lowering operation of the lift operation lever, and the control valve that controls the flow of the hydraulic oil based on the operation of the second operation member, but it may be of a hydraulic type or a mechanical type.

### REFERENCE SIGNS LIST

1 cargo vehicle
4 lift cylinder (first hydraulic cylinder)
4b bottom chamber
6 fork (object to be elevated)
9 tilt cylinder (second hydraulic cylinder)
11 lift operation lever (first operation member)
12 tilt operation lever (second operation member)
13 steering wheel (second operation member)
14 PS cylinder
15 attachment cylinder (second hydraulic cylinder)
16 hydraulic drive device
17 hydraulic pump motor (hydraulic pump)
17a suction port
17b discharge port
18 electric motor (motor)
47 hydraulic pipe (lowering oil path)
48 operation valve
49 hydraulic pipe (bypass oil path)
50 bypass flow rate control valve
61 motor driver (electric motor control unit)
67 command rotational speed setting unit
70 second hydraulic cylinder
73 second operation member

1. A hydraulic drive device for a cargo vehicle, the hydraulic drive device comprising:
a first hydraulic cylinder for raising and lowering that raises and lowers an object to be raised and lowered by supplying and discharging hydraulic oil;
a second hydraulic cylinder for performing an operation different from the first hydraulic cylinder by supplying and discharging the hydraulic oil;
a first operation member that operates the first hydraulic cylinder;
a second operation member that operates the second hydraulic cylinder;
a hydraulic pump that supplies and discharges the hydraulic oil to and from the first hydraulic cylinder and the second hydraulic cylinder;
an electric motor connected to the hydraulic pump and functioning as a motor or a generator;
a lowering oil path connecting a bottom chamber of the first hydraulic cylinder and a suction port of the hydraulic pump so that the hydraulic oil discharged from the first hydraulic cylinder flows to the suction port of the hydraulic pump;
an operation valve that is disposed in the lowering oil path and that controls a flow of hydraulic oil discharged from the first hydraulic cylinder based on a lowering operation of the first operation member;
a bypass oil path that branches off from the lowering oil path at a branch point and that connects the branch point and a tank that stores the hydraulic oil;
a bypass flow rate control valve that is disposed in the bypass oil path and that controls a bypass flow rate which is a flow rate of hydraulic oil flowing from the branch point to the tank;
a command rotational speed setting unit that sets a command rotational speed of the electric motor, and
an electric motor control unit that performs a controlling output to the electric motor based on the command rotational speed of the command rotational speed setting unit and a state of power running torque limit control,
wherein a command rotational speed deceleration which is a deceleration of the command rotational speed set by the command rotational speed setting unit is larger than an actual rotational speed deceleration which is a deceleration of an actual rotational speed of the electric motor by the controlling output of the electric motor control unit.

2. The hydraulic drive device for a cargo vehicle according to claim 1, wherein the command rotational speed deceleration is two times or more as large as the actual rotational speed deceleration.
